(19) United States
(12) Patent Application Publication
(10) Pub. No.: US 2018/0266520 A1
(43) Pub. Date: Sep. 20, 2018

(54) SHIFTING APPARATUS

(71) Applicants: HYUNDAI MOTOR COMPANY, Seoul (KR); KIA MOTORS CORPORATION, Seoul (KR)

(72) Inventor: Jong Yun PARK, Hwaseong-si (KR)

(73) Assignees: HYUNDAI MOTOR COMPANY, Seoul (KR); KIA MOTORS CORPORATION, Seoul (KR)

(21) Appl. No.: 15/707,254

(22) Filed: Sep. 18, 2017

(30) Foreign Application Priority Data
Mar. 17, 2017 (KR) 10-2017-0033997

(51) Int. Cl. F16H 3/10

(52) U.S. Cl. CPC F16H 3/10

(57) ABSTRACT

Disclosed is a shifting apparatus, including: sleeve gear having teeth provided on an inner circumferential surface of a sleeve; and a clutch gear having teeth provided on an outer circumferential surface of a clutch such that the clutch gear teeth are engaged with the sleeve gear teeth by movement of the sleeve in an axial direction. In particular, ends of the sleeve gear teeth facing the clutch gear, and ends of the clutch gear teeth facing the sleeve form flat surfaces perpendicular to the axial direction.

### CROSS REFERENCE TO RELATED APPLICATION

This application claims priority to and the benefit of Korean Patent Application No. 10-2017-0033997, filed on Mar. 17, 2017, which is incorporated herein by reference in its entirety.

### FIELD

The present disclosure relates generally to a shifting apparatus that can be used in a vehicle transmission.

### BACKGROUND

The statements in this section merely provide background information related to the present disclosure and may not constitute prior art.

In general, a shifting apparatus of a vehicle comprises a synchronizer including: a hub rotationally confined to a shaft; a sleeve sliding relative to the hub in its axial direction; a transmission gear forming a speed change gear and rotatably installed at the shaft; a clutch gear provided integrally with the transmission gear and having a conical friction surface; and a synchronizer ring pressed by the sleeve against the conical friction surface of the clutch gear and thus performing a synchronizing action.

The foregoing is intended merely to aid in the understanding of the background of the present disclosure, and is not intended to mean that the present disclosure falls within the purview of the related art that is already known to those skilled in the art.

### SUMMARY

The present disclosure proposes a shifting apparatus for use in an electric-vehicle transmission, which may reduce or eliminate torque interruption by allowing torque transmitted from a motor through an input shaft to be continuously transmitted to an output shaft during a shift, whereby the apparatus can provide efficient shifting operability and can achieve sufficient durability.

In one aspect of the present disclosure, a shifting apparatus includes: sleeve gear teeth provided on an inner circumferential surface of a sleeve; and clutch gear teeth provided on an outer circumferential surface of a clutch gear, the clutch gear teeth configured to engage with the sleeve gear teeth by movement of the sleeve in an axial direction, wherein ends of the sleeve gear teeth toward the clutch gear, and ends of the clutch gear teeth toward the sleeve form flat surfaces perpendicular to the axial direction.

A friction cone may be integrally provided at the clutch gear, a blocking ring may be provided between the sleeve and the clutch gear, a counter cone is formed on an inner surface of the blocking ring, the counter cone configured to receive the friction cone, and a key may be radially elastically supported inside the sleeve.

A sleeve groove is formed on the inner circumferential surface of the sleeve, and the sleeve groove is configured to allow a radial displacement of the key in response to the movement of the sleeve in the axial direction. The blocking ring may be provided with blocking inclined surfaces having a circumferential gap between the blocking inclined surfaces, and the circumferential gap is gradually narrowed in a radially inward direction such that when the blocking inclined surfaces are brought into contact with the key, an indexing torque is generated by a radially inward displacement of the key.

The blocking ring may be provided with a pair of axial protrusions placed adjacent to each other and protruding toward the key, the pair of axial protrusions is configured to form the blocking inclined surfaces, and the blocking inclined surfaces may be formed on the pair of axial protrusions so as to face to each other.

A key protrusion may be formed on a radial outer surface of the key and protrudes from a center of the key toward the inner circumferential surface of the sleeve in the axial direction, the key protrusion being inserted into the sleeve groove, and the key may be provided with counter-inclined surfaces on a radial inner surface thereof at circumferentially opposite sides to the key protrusion, the counter-inclined surfaces configured to receive the blocking inclined surfaces.

A hub may be provided to constantly transmit and receive torque to and from an input shaft, and the clutch gear may be provided to transmit and receive torque to and from the input shaft regardless of an axial position of the sleeve relative to the clutch gear.

A hub may be provided to constantly transmit and receive torque to and from an output shaft, and the clutch gear may be provided to transmit and receive torque to and from the output shaft regardless of an axial position of the sleeve relative to the clutch gear.

The clutch gear may be integrally connected to a speed change gear, and the speed change gear may be connected to a servo clutch so as to transmit torque to a shaft provided with the clutch gear.

The input shaft may be directly connected to a motor.

The present disclosure can be used in an electric-vehicle transmission that reduces or eliminates torque interruption or torque by allowing torque transmitted from a motor through an input shaft to be continuously transmitted to an output shaft during a shift, thereby providing efficient shifting operability and achieving sufficient durability.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view showing a configuration of a shifting apparatus in one form of the present disclosure;

FIG. 2 is a cross-sectional view showing an assembled state of the shifting apparatus in one form of the present disclosure;

FIG. 3 is a detailed view showing a main part of a blocking ring of FIG. 1;

FIG. 4 is a detailed view showing a key of FIG. 1;

FIGS. 5 and 6 are views showing examples of an electric-vehicle transmission to which the present disclosure can be applied;

FIG. 7 is a view showing a process of engaging sleeve gear teeth with clutch gear teeth according to the present disclosure; and

FIG. 8 is a view showing a process of engaging sleeve gear teeth with clutch gear teeth in the prior art.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

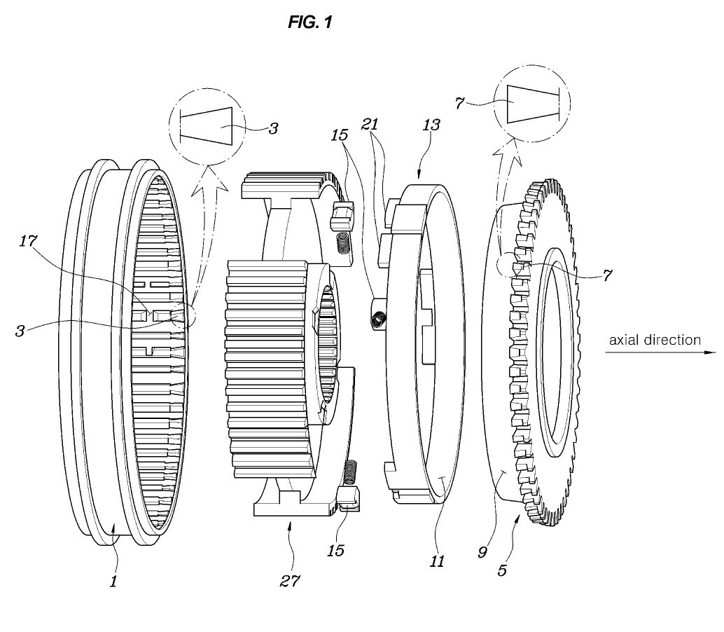

Referring to FIGS. 1 to 7, a shifting apparatus in one form of the present disclosure comprises: sleeve gear teeth 3 provided on an inner circumferential surface of a sleeve 1; and clutch gear teeth 7 provided on an outer circumferential surface of a clutch gear 5 such that the clutch gear teeth 7 are engaged with the sleeve gear teeth 3 of the sleeve 1 by movement of the sleeve 1 in an axial direction.

Here, ends of the sleeve gear teeth 3 that face toward the clutch gear 5 and ends of the clutch gear teeth 7 that face toward the sleeve 1 form flat surfaces perpendicular to the axial direction.

In other words, the ends of the sleeve gear teeth 3 and the ends of the clutch gear teeth 7 that face each other form flat surfaces parallel to each other rather than forming inclined chamfered surfaces.

Here, the axial direction means a longitudinal direction (i.e., the direction of a rotation center axis) of the sleeve 1 and the clutch gear 5, a radial direction means a linear direction perpendicular to the rotation center axis, and a circumferential direction means a direction of an arc along a circumference of the sleeve 1 or the clutch gear 5.

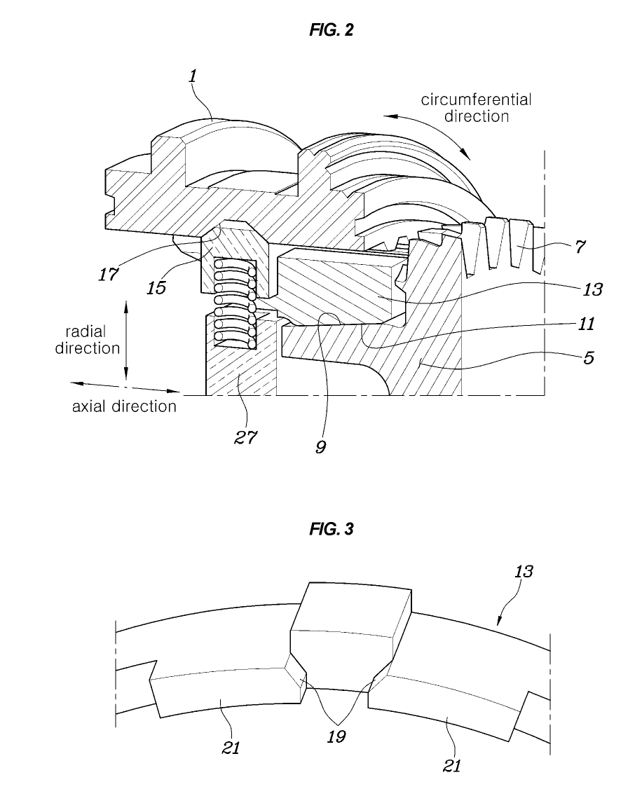

A friction cone 9 is integrally provided at the clutch gear 5, and a blocking ring 13 is provided between the sleeve 1 and the clutch gear 5, and a key 15 is radially elastically supported inside the sleeve 1. The blocking ring 13 is provided with a counter cone 11 on an inner surface of the blocking ring, and the counter cone 11 receives the friction cone 9 as illustrated in FIG. 2.

The sleeve 1 is provided, on the inner circumferential surface thereof, with a sleeve groove 17 that allows radial displacement of the key 15 in response to the movement of the sleeve 1 in the axial direction, and the blocking ring 13 is provided with blocking inclined surfaces 19 having a circumferential gap therebetween that is gradually narrowed in a radially inward direction such that when the blocking inclined surfaces 19 are brought into contact with the key 15, an indexing torque is generated by radially inward displacement of the key 15.

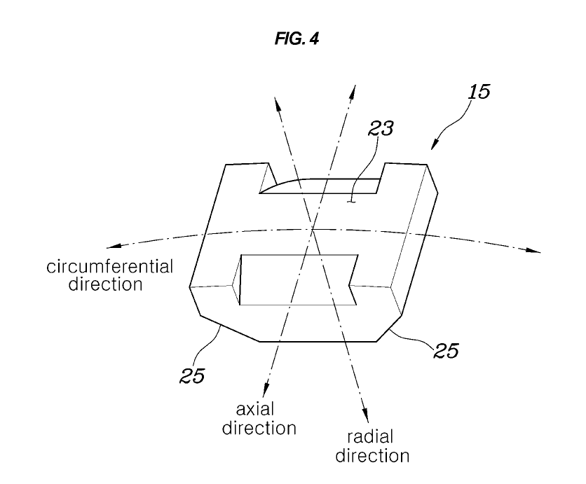

As shown in detail in FIG. 3, the blocking ring 13 is provided with a pair of axial protrusions 21 placed adjacent to each other and protruding toward the key 15 to form the blocking inclined surfaces 19, and the blocking inclined surfaces 19 are formed on the adjacent axial protrusions 21 to face to each other.

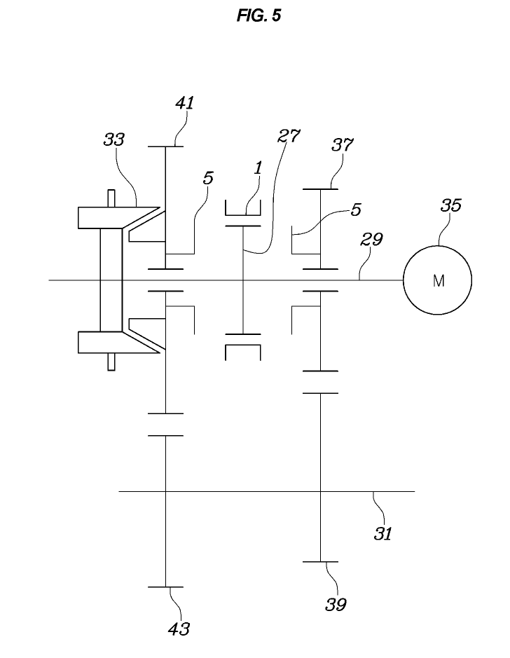

As shown in detail in FIG. 4, the key 15 is provided with a key protrusion 23 protruding from a center of the key 15 toward the inner circumferential surface of the sleeve 1 in the axial direction, and being inserted into the sleeve groove 17, and is provided with counter-inclined surfaces 25 on a radial inner surface thereof at circumferentially opposite sides of the key 15 to correspond to the blocking inclined surfaces 19.

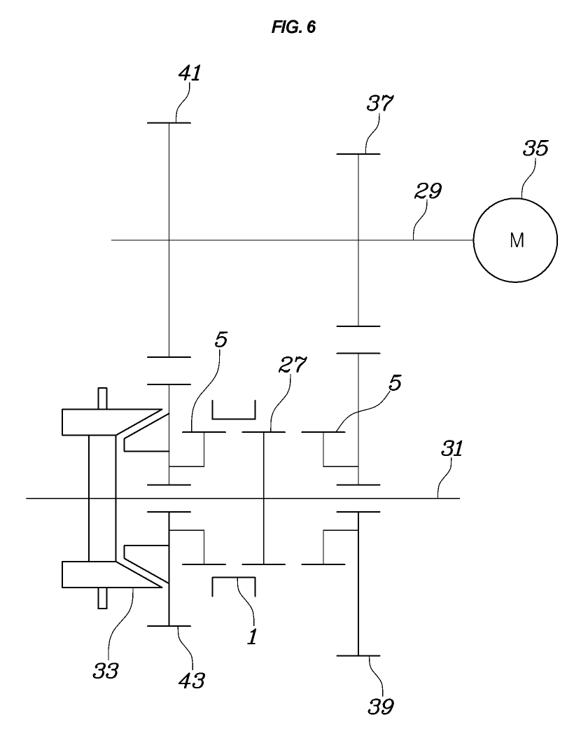

Meanwhile, FIG. 5 shows a configuration of an electric-vehicle transmission to which the present disclosure can be applied. A hub 27 is installed to constantly transmit and receive torque to and from an input shaft 29, and the clutch gear 5 is installed to transmit and receive torque to and from the input shaft 29 regardless of an axial position of the sleeve 1 relative to the clutch gear 5.

Further, in a configuration of the transmission of FIG. 6, a hub 27 is installed to constantly transmit and receive torque to and from an output shaft 31, and the clutch gear 5 is installed to transmit and receive torque to and from the output shaft 31 regardless of the axial position of the sleeve 1 relative to the clutch gear 5.

In the transmissions of FIGS. 5 and 6, the clutch gear 5 is integrally connected to a speed change gear, and the speed change gear is connected to a servo clutch 33 so as to transmit torque to a shaft provided with the clutch gear 5. Thus, the clutch gear 5 is able to transmit and receive torque to and from the input shaft 29 or the output shaft 31, respectively, regardless of the axial position of the sleeve 1.

Both the transmission of FIG. 5 and the transmission of FIG. 6 have a common configuration that the input shaft 29 is directly connected to a motor 35, and a clutch gear to which the present disclosure is applied is the clutch gear 5 connected to the speed change gear connected to the servo clutch 33.

In the transmission of FIG. 5, a first driving gear 37 is rotatably installed on the input shaft 29, and a first driven gear 39 is installed on the output shaft 31 in a state in which rotation thereof is restrained. A second driving gear 41 is rotatably installed on the input shaft 29, and a second driven gear 43 is installed on the output shaft 31 in a state in which rotation thereof is restrained. The input shaft 29 is provided with the shifting apparatus such as the hub 27, the sleeve 1, etc. to which the present disclosure is applied.

Here, the first driving gear 37, the second driving gear 41, the first driven gear 39, and the second driven gear 43 are collectively referred to as a speed change gear. The second driving gear 41 is integrally connected with the clutch gear 5 to which the present disclosure is applied.

In the process of shifting a first gear to a second gear in the transmission of FIG. 5, the sleeve 1 is engaged with the clutch gear 5 connected to the first driving gear 37 to form a first-gear drive state. Then, when a shift command to the second gear is generated, the servo clutch 33 is controlled such that a part of power of the motor 35 is directly transmitted to the second driving gear 41 via the input shaft 29. Thereafter, even when the sleeve 1 is released from the clutch gear 5 connected to the first driving gear 37 and forms a neutral state, torque is constantly transmitted from the motor 35 to the output shaft 31, and thus torque interruption can be reduced or eliminated.

When the sleeve 1 is pressed toward the second driving gear 41 from the neutral state, the sleeve 1 presses the key 15 in the axial direction toward the second driving gear 41 such that the key 15 brings the blocking ring 13 into frictional contact with the friction cone 9 of the clutch gear 5, by which synchronization is performed. In addition, the key 15 is pressed in the radially inward direction by the sleeve groove 17 of the sleeve 1.

The radially inward movement of the key 15 is blocked by the frictional force between the blocking inclined surfaces 19 of the blocking ring 13 and the counter-inclined surfaces 25 of the key 15 until synchronization is complete. When synchronization is completed, the indexing torque is generated by slidable relationship of the blocking inclined surfaces 19 and the counter-inclined surfaces 25, and accordingly the blocking ring 13 is slightly rotated with respect to the sleeve 1, whereby indexing is performed.

A shifting apparatus in which a synchronizer ring corresponding to the blocking ring 13 is used is called indexing. Indexing refers to a condition where locking teeth provided on an outer circumferential surface of the synchronizer ring and sleeve gear teeth provided on an inner circumferential surface of a sleeve are aligned while inclined chamfered surfaces thereof slide relative to each other, whereby the sleeve gear teeth are allowed to move through the locking teeth toward the clutch gear teeth. Here, performing the indexing means that the sleeve 1 is able to move toward the clutch gear 5 of the second driving gear 41 by aligning the blocking ring 13 with the key 15 while the key 15 moves in the radially inward direction with respect to the movement of the sleeve 1 in the axial direction.

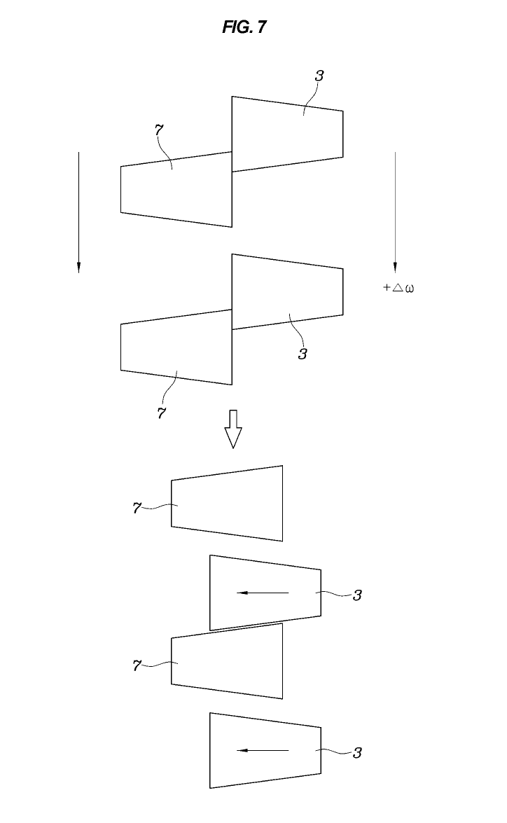

After the indexing, the sleeve 1 continues to move in the axial direction, such that the sleeve gear teeth 3 are engaged with the clutch gear teeth 7. In the present disclosure, this state is shown in FIG. 7.

FIG. 7 shows a process in which ends of the sleeve gear teeth 3 and ends of the clutch gear teeth 7 come into contact with each other in a planar relationship, such that the sleeve gear teeth 3 are engaged with the clutch gear teeth 7. It is shown that if a certain period of time has elapsed even in the state in which the ends of the sleeve gear teeth 3 are in contact with the ends of the clutch gear teeth 7, the engagement is naturally performed by difference in the number of rotations between the sleeve 1 and the clutch gear 5.

In other words, in the shifting apparatus of the present disclosure, the engagement state between the sleeve gear teeth 3 and the clutch gear teeth 7 is divided into two major ways. One is that the sleeve gear teeth 3 are aligned between clutch gear teeth 7 to be directly inserted therebetween, and the other is that as shown in FIG. 7, the sleeve gear teeth 3 and the clutch gear teeth 7 come into contact with each other in a misaligned state, and then if a certain period of time has elapsed, they are engaged with each other at the moment of alignment due to the difference in the number of rotations.

Although the above-mentioned direct engagement state is desirable, such state cannot always be formed but the state shown in FIG. 7 is usually achieved. In this case, since the end portions of the sleeve gear teeth 3 and the clutch gear teeth 7 are in planar contact with each other, the sleeve gear teeth 3 and the clutch gear teeth 7 are inhibited or prevented from being broken or abraded when they are in contact with each other. Thus, it is expected that when a certain period of time has elapsed after the state shown in FIG. 7 is formed, gear engagement can be naturally and efficiently performed.

For reference, when the sleeve 1 moves toward the clutch gear 5 after the indexing, the key 15 is displaced from the sleeve groove 17 and the force of the key 15 to bring the blocking ring 13 into close contact with the friction cone 9 of the clutch gear 5 is reduced. Accordingly, the synchronized state collapses for a short period of time and the relative speed between the sleeve 1 and clutch gear 5 is generated, whereby the engagement due to the speed difference between the sleeve gear teeth 3 and the clutch gear teeth 7 is possible as shown in FIG. 7.

Moreover, in the engagement process shown in FIG. 7, the second driving gear 41 is in a state where it can constantly transmit and receive torque to and from the output shaft 31, and the sleeve 1 is directly connected to the motor 35 generating torque, whereby both the sleeve gear teeth 3 and the clutch gear teeth 7 are in a state of transmitting torque, which is different from a conventional shifting apparatus in which either the sleeve gear teeth 3 or the clutch gear teeth 7 is in a free-rotating state without transmitting torque to be synchronized with the remaining gear teeth.

In other words, according to the present disclosure, since a shift is performed while both the sleeve gear teeth 3 and the clutch gear teeth 7 transmit torque, it is possible to obtain the effect of substantially reducing or eliminating torque interruption and to efficiently perform the shift.

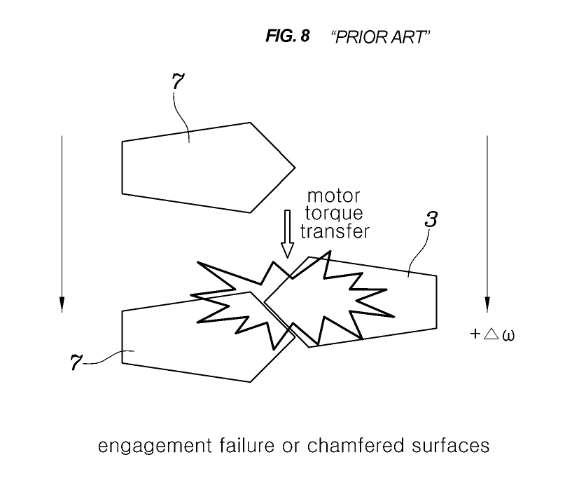

In particular, in the operation of the conventional shifting apparatus as shown in FIG. 8, the conventional shifting apparatus includes a clutch gear teeth 7 and a sleeve gear teeth 3, which correspond to those of the present disclosure (which will be described with the same name as the present disclosure for convenience), and each of them have inclined chamfered surfaces at ends thereof. Thus, when the sleeve gear teeth 3 are inserted between clutch gear teeth 7, the chamfered surfaces cause relative rotation, and thus efficient engagement can be performed.

However, in order to be able to perform engagement by causing the relative rotation by the chamfered surfaces as described above, any one of the sleeve gear teeth 3 or the clutch gear teeth 7 should be in a state of freely rotating on the shaft without actively transmitting and receiving torque to and from the outside, so that the relative rotation can be achieved when only the inertia force is overcome. Accordingly, in the configuration in which both the sleeve gear teeth 3 and the clutch gear teeth 7 transmit torque as in the present disclosure, the problem as shown in FIG. 8 occurs.

In other words, in the case of FIG. 8, when the relative speed of the sleeve gear teeth 3 is faster than that of the clutch gear teeth 7 by Δω, the sleeve gear teeth 3 are in the state of transmitting torque of the motor 35. Accordingly, frictional force is continuously generated on the chamfered surfaces of both the sleeve gear teeth 3 and the clutch gear teeth 7, and the relative rotation of the sleeve gear teeth 3 with respect to the clutch gear teeth 7 does not occur. As a result, it is difficult to perform engagement, and the chamfered surfaces of the sleeve gear teeth 3 and the clutch gear teeth 7 may be broken.

Of course, in the case that torque of the motor 35 is not transmitted to the sleeve gear teeth 3, and the shift is performed in a state where the input shaft is blocked by the clutch from the engine or the motor as in a conventional manual transmission vehicle, since the sleeve gear teeth 3 are not in a state of transmitting the torque, the sleeve gear teeth 3 rotate in an opposite direction relative to a rotation direction of the clutch gear teeth 7 while they slide relative to each other by the chamfered surfaces, whereby engagement is performed.

As described above, according to the present disclosure, efficient and stable engagement between the sleeve gear teeth 3 and the clutch gear teeth 7 can be achieved in a transmission in which a shift is made while preventing torque interruption. Thus, it is possible to secure the shifting reliability and to secure the durability of the sleeve gear teeth 3 and the clutch gear teeth 7.

For reference, the shifting apparatus of the present disclosure may be also used in a transmission having the configuration of FIG. 6, thereby performing the same operation as that of the transmission of FIG. 5. The detailed description of the operation is omitted because it is almost the same as the transmission of FIG. 5.

Although exemplarly forms of the present disclosure have been described for illustrative purposes, those skilled in the art will appreciate that various modifications, additions and substitutions are possible, without departing from the scope and spirit of the present disclosure

What is claimed is:

1. A shifting apparatus, comprising:
sleeve gear teeth provided on an inner circumferential surface of a sleeve; and
clutch gear teeth provided on an outer circumferential surface of a clutch gear, the clutch gear teeth configured to engage with the sleeve gear teeth by movement of the sleeve in an axial direction,
wherein ends of the sleeve gear teeth toward the clutch gear, and ends of the clutch gear teeth toward the sleeve form flat surfaces perpendicular to the axial direction.

2. The shifting apparatus of claim 1, wherein
a friction cone is integrally provided at the clutch gear,
a blocking ring is provided between the sleeve and the clutch gear,
a counter cone is formed on an inner surface of the blocking ring, the counter cone configured to receive the friction cone, and
a key is radially elastically supported inside the sleeve.

3. The shifting apparatus of claim 2, wherein
a sleeve groove is formed on the inner circumferential surface of the sleeve, and the sleeve groove is configured to allow a radial displacement of the key in response to the movement of the sleeve in the axial direction, and
wherein the blocking ring is provided with blocking inclined surfaces having a circumferential gap therebetween, the circumferential gap is gradually narrowed in a radially inward direction such that when the blocking inclined surfaces contact with the key, an indexing torque is generated by a radially inward displacement of the key.

4. The shifting apparatus of claim 3, wherein
the blocking ring is provided with a pair of axial protrusions placed adjacent to each other and protruding toward the key, the pair of axial protrusions configured to form the blocking inclined surfaces, and
the blocking inclined surfaces are formed on the pair of axial protrusions so as to face to each other.

5. The shifting apparatus of claim 3, wherein
a key protrusion is formed on a radial outer surface of the key and protrudes from a center of the key toward the inner circumferential surface of the sleeve in the axial direction, the key protrusion being inserted into the sleeve groove, and the key is provided with counter-inclined surfaces on a radial inner surface thereof at circumferentially opposite sides to the key protrusion, the counter-inclined surfaces configured receive the blocking inclined surfaces.

6. The shifting apparatus of claim 1, wherein
a hub is configured to constantly transmit and receive torque to and from an input shaft, and
the clutch gear is configured to transmit and receive torque to and from the input shaft regardless of an axial position of the sleeve relative to the clutch gear.

7. The shifting apparatus of claim 6, wherein the input shaft is directly connected to a motor.

8. The shifting apparatus of claim 1, wherein
a hub is configured to constantly transmit and receive torque to and from an output shaft, and
the clutch gear is configured to transmit and receive torque to and from the output shaft regardless of an axial position of the sleeve relative to the clutch gear.

9. The shifting apparatus of claim 1, wherein
the clutch gear is integrally connected to a speed change gear, and
the speed change gear is connected to a servo clutch so as to transmit torque to a shaft provided with the clutch gear.

10. A shifting apparatus, comprising:
a sleeve defining an axial direction, the sleeve having an inner circumferential surface defining sleeve gear teeth; and
a clutch gear having an outer circumferential surface defining clutch gear teeth, the clutch gear teeth configured to engage with the sleeve gear teeth by movement of the sleeve in the axial direction,
wherein the sleeve gear teeth have ends facing towards the clutch gear, and the clutch gear teeth have ends facing towards the sleeve, and wherein the ends of the clutch gear teeth and the sleeve gear teeth have flat surfaces perpendicular to the axial direction.

11. The shifting apparatus of claim 10, wherein the ends of the sleeve gear teeth and clutch gear teeth are not formed as inclined chamfered surfaces.
